(19) United States
(12) Patent Application Publication
(10) Pub. No.: US 2001/0022684 A1
(43) Pub. Date: Sep. 20, 2001

(54) Optical amplifier and wavelength multiplexing optical transmission system

(75) Inventor: Kiyoto Kobayashi, Miyagi (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/802,812

(22) Filed: Mar. 9, 2001

(30) Foreign Application Priority Data
Mar. 13, 2000 (JP) 68694/2000

(51) Int. Cl. H01S 3/00

(52) U.S. Cl. 359/341.41

(57) ABSTRACT

An optical amplifier amplifies and outputs wavelength multiplexed signal lights and a pilot light. The pilot light has a wavelength different from that of the wavelength multiplexed signal lights and a low frequency Tone signal is superposed thereon. The amplified lights are converted into electric signals, and then a Tone signal is selected. A controlling circuit controls an excitation light so that level of the Tone signal will be fixed. A pilot light generating circuit outputs a pilot light having a Tone signal of a constantly fixed level superposed thereon.

### BACKGROUND OF THE INVENTION

1. Field of the Invention

The present invention relates to an optical amplifier, in particular to an optical amplifier of which gain is controllable and a wavelength multiplexing optical transmission system equipped with the optical amplifier.

2. Description of the Related Prior Art

Wave Division Multiplexing (hereafter WDM) technology is an optical transmission technology for multiplexing a plurality of signal lights of different wavelengths to increase transmission capacity. In a WDM optical transmission system, an optical amplifier is usually mounted on an optical transmitter, an optical repeater and an optical receiver. This optical amplifier basically amplifies inputted wavelength multiplexed lights so that output lights will remain at fixed total power level. In reality, however, this optical amplifier is controlled so that, out of inputted wavelength multiplexed signal lights, output power level per one signal light will constantly remain fixed.

In recent years, WDM optical transmission systems more complicated than the conventional ones are utilized because of development of optical networks and increase in communication traffic. For instance, configuration in which WDM systems are mutually connected in tandem, Optical Add/Drop Multiplexing system (hereafter OADM system) wherein light signals are directly added/dropped, and Ring configuration are known. These complicated systems have increased opportunities to dynamically change the number of multiplexed signal lights in operation. Also, even in the case where a signal break occurs due to an accident such as an optical fiber break, there are surviving signal lights in an OADM system and so on. Thus, in case there is an accident, communication using such surviving signal lights must be maintained. To be more specific, useable signal light level must be maintained at a normal value.

For the purpose of controlling optical output level per signal light to be fixed, Japanese Patent Laid-Open No. 9-97941 and Japanese Patent Laid-Open No. 11-215102 disclose WDM optical transmission systems wherein one arbitrary light signal in wavelength multiplexed signal lights is modulated at a predetermined frequency and level of the predetermined frequency component is detected from the wavelength multiple signal light amplified by an optical amplifier, and then gain of the optical amplifier is controlled based on the detected value. However, one signal light in wavelength multiplexed signal lights sent from a transmitter as a supervising light is used, and thus this system cannot avoid any influence exerted on other signals in the case where a signal break due to a transmitter failure or an accident occurs or in the case of a system wherein a light signal path is changed such as OADM or optical cross-connect.

In addition, Japanese Patent No. 2787820 discloses a WDM optical transmission systems wherein wavelength multiplexed signal lights are multiplexed with another supervising light of a different wavelength and controlled so that the level of the supervising light amplified by an optical amplifier remains fixed. However, this technique requires a band pass filter in order to extract a supervising light of specific wavelength from output of the optical amplifier and it requires a complicated equipment configuration for the purpose of strict management of a supervising light wavelength.

### SUMMARY OF THE INVENTION

Thus, an object of the present invention is to provide an optical amplifier and a wavelength multiple optical communication system capable of coping with both abrupt and great change of the number of multiplexed signal lights and relief of surviving signals on a signal break due to an accident such as a fiber break.

A first optical amplifier of the present invention is equipped with a light amplifying medium for amplifying an input light, an excitation light source for sending an excitation light to this light amplifying medium, a light branching device for branching an amplified light, a signal detecting circuit for detecting a predetermined low frequency signal from branched lights, and a gain controlling circuit for controlling amplification gain of the light amplifying medium based on a detected low frequency signal. In addition, a second optical amplifier of the present invention is equipped with the above described configuration, and further a pilot light generating circuit for generating a pilot light having a wavelength different from wavelength multiplexed signal lights included in the input light and a low frequency signal superposed thereon, and an optical multiplexer for inputting the pilot light to the light amplifying medium.

In the wavelength multiple optical communication system of the present invention, an optical transmitting station is equipped with a wavelength multiplexing device for multiplexing a plurality of signal lights and the above second optical amplifier for amplifying the wavelength-multiplexed signal lights.

In the wavelength multiple optical communication system, at least one of light relay station and light receiving station can have the above described first optical amplifier.

### BRIEF DESCRIPTION OF THE DRAWINGS

The above and other objects, features and advantages of the present invention will become apparent from the following detailed description when taken with the accompanying drawings in which:

FIG. 1 is a block diagram of a conventional WDM optical transmission system;

FIG. 2 is a block diagram of an optical amplifier and a WDM optical transmission system;

FIG. 3 is a block diagram showing an example of a pilot signal generating circuit; and

FIG. 4 is a block diagram showing an example of an optical amplifier.

### DETAILED DESCRIPTION OF THE PREFERRED EMBODIMENTS

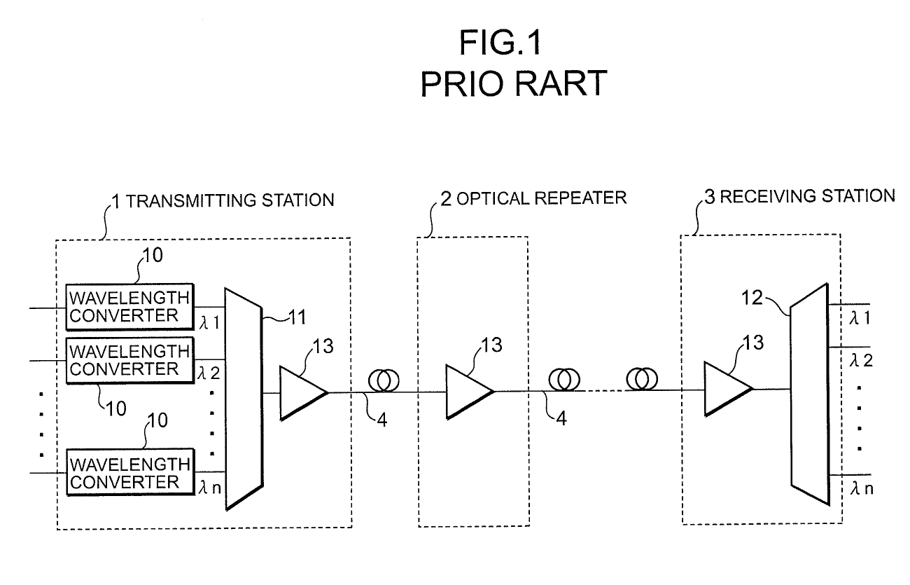

Referring to FIG. 1, in a conventional WDM optical transmission system, transmitting station 1 is equipped with n pieces of wavelength converter 10, wavelength multiplexer 11 for multiplexing signal lights of n waves of different wavelengths and optical amplifier 13. Also, light receiving station 3 of the system is equipped with optical amplifier 13 and wavelength demultiplexer 12. In addition, an optical repeater placed on optical transmission path 4 is also equipped with optical amplifier 13. These optical amplifiers 13 basically amplify inputted wavelength multiple lights so as to keep outputted lights at fixed total power level. Thus, if the number of wavelength multiplexed signal lights changes, output power level per signal light changes. As in the above described document, however, this optical amplifier is controlled so that output power level per signal light of inputted wavelength multiplexed signal lights constantly remains fixed.

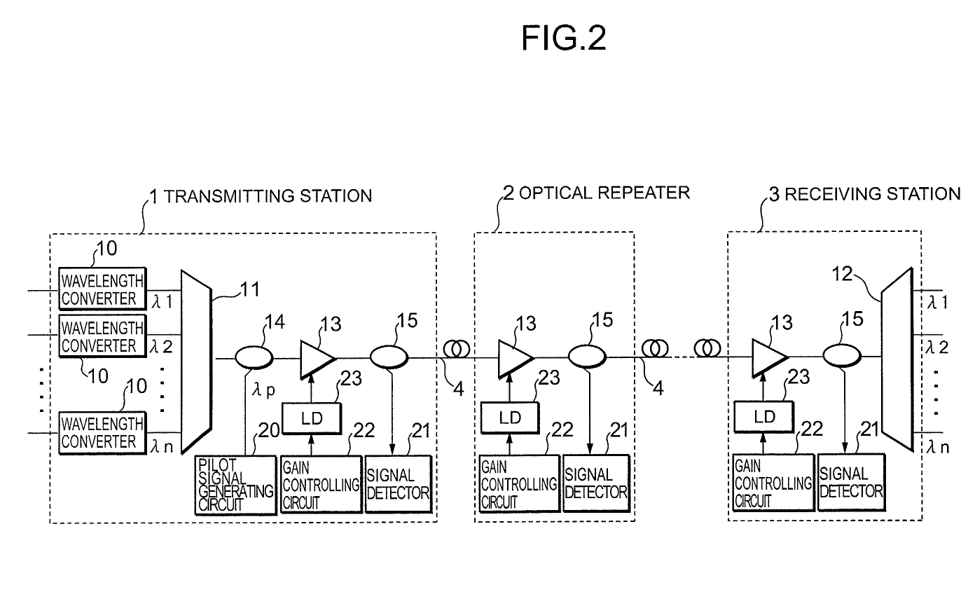

Referring to FIG. 2, in a WDM optical transmission system of the present invention, transmitting station 1 is equipped with optical amplifier 13 (for instance, an erbium-doped optical fiber) on the output side of wavelength multiplexer 11. The optical amplifier 13 is equipped with, on its input side, optical multiplexer 14 and pilot light generating circuit 20 for sending to optical amplifier 13 via optical multiplexer 14 a pilot light having a predetermined low frequency signal superposed thereon. Moreover, optical amplifier 13 is equipped with, on its output side, light branching device 15 and signal detector 21 for detecting from branched lights thereof the above predetermined low frequency signal. Furthermore, the optical amplifier 13 is equipped with LD23 for outputting an excitation light and a gain controlling circuit for controlling the excitation light and then controlling gain based on the above detected low frequency signal. Optical repeater 2 and optical receiver 3 in the WDM optical transmission system are also equipped with optical amplifier 13. These optical amplifier are also equipped with, just as the above described, on its output side, light branching device 15, signal detector 21 for detecting a predetermined low frequency signal from the branched lights, LD23 for outputting an excitation light and a gain controlling circuit for controlling the excitation light and then controlling gain based on the detected low frequency signal. Optical receiver 3 is equipped with wavelength demultiplexer 12 for dividing an amplified light into signal lights of respective wavelengths.

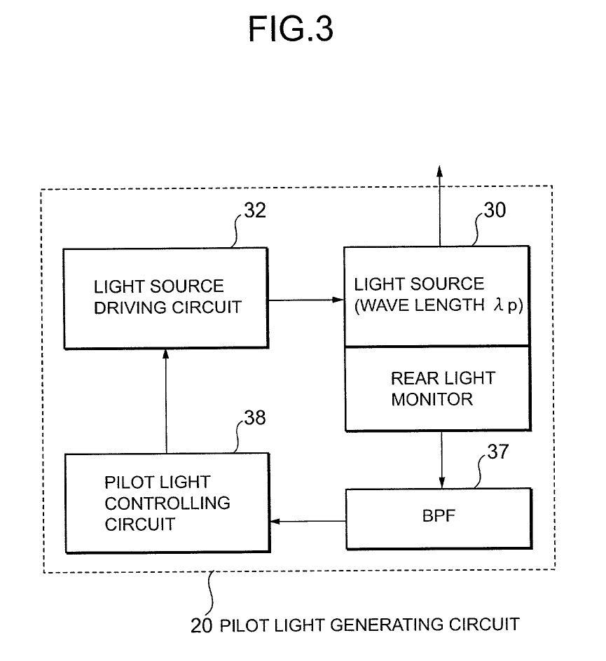

Referring to FIG. 3, pilot light generating circuit 20 is equipped with pilot light (wavelength λp) light source with a rear light monitor 30, light source driving circuit 32 for driving the light source 30 and pilot light modulating and controlling circuit 38 for controlling the light source driving circuit 32 and superposing a low frequency signal (Tone signal) on a pilot light. Band pass filter 37 for selecting the above low frequency signal is placed between the rear light monitor and the controlling circuit 38.

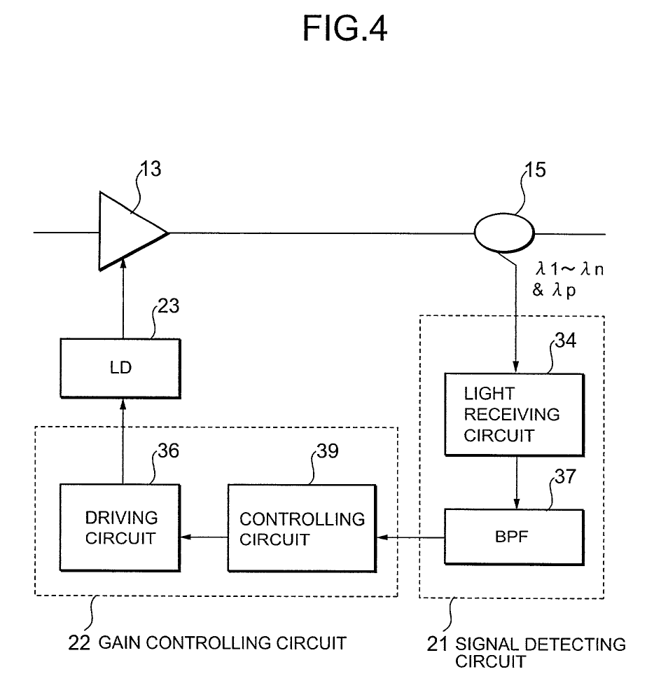

FIG. 4 shows an example of a feedback loop of optical amplifier 13. As shown in FIG. 2, the feedback loop is equipped with light branching device 15, signal detector 21, gain controlling circuit 22 and LD23. Light branching device 15 branches amplified wavelength multiplexed signal lights (wavelength λ1 to λn) and the pilot light (wavelength λp) Signal detecting circuit 21 is equipped with light receiving circuit 34 for receiving branched lights and converting them into electric signals and band pass filter 37 for selecting a predetermined low frequency signal from the electric signals. Gain controlling circuit 22 is equipped with controlling circuit 39 for controlling an excitation light based on amplitude values of the electric signals to control gain of optical amplifier 13, and LD driving circuit 36.

Operation of an optical amplifier is described as follows. In a conventional WDM optical transmission system of the present invention, pilot light generating circuit 20 mounted in the transmitting station outputs a pilot light of a different wavelength (wavelength λp) from wavelength multiplexed signal lights (wavelength λ1 to λn). Pilot light modulating and controlling circuit 38 in pilot light generating circuit 20 controls light source driving circuit 32 so that a Tone signal of a low frequency at fixed level will be constantly superposed on a pilot light. For this purpose, it monitors rear lights of the pilot light via bandpass filter 37. Optical multiplexer 14 merges the pilot signal light on which a Tone signal is superposed with the wavelength multiplexed signal lights and send them to optical amplifier 13 (light amplifying medium).

Optical amplifier 13 amplifies with an excitation light from LD23 wavelength multiplexed signal lights (wavelength λ1 to λn) and the pilot light (wavelength λp) on which a Tone signal are superposed, and outputs them. Light branching device 15 branches these lights and sends them to light receiving circuit 34. Light receiving circuit 34 receives these signal lights and converts them into electric signals. Band pass filter 37 selects a Tone signal of a low frequency superposed on the pilot light from these electric signals and sends it to controlling circuit 39 of gain controlling circuit 22. Controlling circuit 39 detects peak-to-peak crest value level of the received Tone signal, and controls LD driving circuit 36 so that this level will be a predetermined fixed value. Consequently, level of an excitation light sent from LD23 is controlled, and gain of optical amplifier 13 is adjusted. The above described gain control of optical amplifier 13 is performed at the transmitting station, light relay station and receiving station.

In the above described WDM optical transmission system, gain of an optical amplifier is kept fixed, so power level of each signal light of WDM signal lights is kept fixed even if the signal light to be multiplexed changes abruptly and significantly or loss of the optical transmission system changes. While a pilot light does not require strict management of a wavelength, it must be a wavelength that can be amplified by an optical amplifier just as other wavelength multiplexed signal lights.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. An optical amplifier for directly amplifying input lights, comprising:
a light amplifying medium for amplifying input lights;
an excitation light source for sending an excitation light to said light amplifying medium;
a light branching device for branching the amplified lights;
a signal detecting circuit for detecting a predetermined low frequency signal from the branched light; and
a gain controlling circuit for controlling an amplification gain of said light amplifying medium based on said detected low frequency signal.

2. The optical amplifier according to claim 1, wherein the input light include wavelength multiplexed signal lights and a pilot light having a wavelength different from the wavelength multiplexed signal lights, and said low frequency signal is superposed on the pilot light.

3. The optical amplifier according to claim 1, wherein said gain controlling circuit controls the amplification gain so that a level of the detected low frequency signal remains fixed.

4. The optical amplifier according to claim 1, further comprising:
a pilot light generating circuit for a generating pilot light having a wavelength different from wavelength multiplexed signal lights and the low frequency signal superposed thereon; and
an optical multiplexer for inputting the pilot light to said light amplifying medium.

5. The optical amplifier according to claim 1,
wherein said a signal detecting circuit comprises;
a light receiving circuit; and
a band pass filter for selecting said low frequency signal from electric signals output by the light receiving circuit, and
said gain controlling circuit comprises;
a controlling circuit for controlling the amplification gain of said light amplifying medium at fixed level based on an amplitude value of said low frequency signal; and
an excitation light source driving circuit.

6. A wavelength multiplexing optical transmission system, comprising:
an optical transmitting station,
an optical repeater, and
an optical receiving station,
wherein the transmitting station comprises;
a wavelength multiplexing device for multiplexing a plurality of signal lights; and
an optical amplifier for amplifying the wavelength multiplexed signal lights, and
said amplifier comprises;
a light amplifying medium for amplifying input lights;
an excitation light source for sending an excitation light to the light amplifying medium;
a light branching device for branching the amplified light;
a signal detecting circuit for detecting a predetermined low frequency signal from the branched light;
a gain controlling circuit for controlling an amplification gain of said light amplifying medium based on the detected low frequency signal;
a pilot light generating circuit for generating a pilot light having a wavelength different from the wavelength multiplexed signal lights input to said light amplifying medium and a low frequency signal superposed thereon; and
an optical multiplexer for inputting the pilot light to said light amplifying medium.

7. The wavelength multiple optical communication system according to claim 6, wherein at least one of the optical repeater and the optical receiving station comprises the optical amplifier, and
the optical amplifier comprises:
a light amplifying medium for amplifying input light;
an excitation light source for sending an excitation light to the light amplifying medium;
a light branching device for branching the amplified light;
a signal detecting circuit for detecting a predetermined low frequency signal from the branched light; and
a gain controlling circuit for controlling an amplification gain of said light amplifying medium based on said detected low frequency signal.
